(19) United States
(12) Patent Application Publication
(10) Pub. No.: US 2011/0078244 A1
(43) Pub. Date: Mar. 31, 2011

(54) Method for Conveniently and Anonymously Obtaining Information Relating to an Internet Advertisement

(76) Inventors: David D. Minter, Littleton, CO (US); Albert S. Baldocchi, Boulder, CO (US)

(21) Appl. No.: 12/962,589

(22) Filed: Dec. 7, 2010

(51) Int. Cl. G06F 15/16

(52) U.S. Cl. 709/204

(57) ABSTRACT

The present invention is directed to a system in which a Web advertisement provided over the Internet to a user's computer allows the user to receive additional information on the advertised product or service over or through a communication channel specified by the user and preserves the user's anonymity. In one embodiment, the Web advertisement includes a “button” that, if actuated, causes a request for further information to be transmitted over the Internet to an intermediary computer system. The intermediary computer system then processes the request to produce a revised request that is forwarded to an advertiser computer system and is tagged so that the reply from the advertiser computer system can be associated with the user. The reply that the intermediary computer system receives from the advertiser computer system is matched with the user and a revised reply is produced that is communicated to the user or a device associated with the user via the communication channel designated by the user.

### FIELD OF THE INVENTION

The present invention is related to Internet advertisements and, more specifically, to the providing of information related to an advertisement to a user.

### BACKGROUND OF THE INVENTION

The evolution of the Internet as a tool for information flow, communication and commerce has fundamentally altered the United States and world economies. As part of this evolutionary process, Web publishers have tested and used a variety of economic models to finance their operations, such as e-commerce, subscription services, search-placement fees and referral fees. One of the most successful and widely-used economic models is advertising. Although such advertising can take many visual and audio forms, the banner ad is today among the most popular forms of Web advertising.

Banner ads can be used strictly as billboards, but are more typically used as a gateway to an advertiser's site where a user can access more information. Thus, the effectiveness of banner ads on the Internet is typically measured in terms of click-through rates. A click-through rate is the ratio of users who click on an ad to the number of times the banner ad is delivered. As the Internet and Internet banner advertising has grown over time, click-through rates have steadily declined. Current click-through rates are estimated today to be between 0.2 and 0.3 percent.

Much effort has gone into improving the content and delivery of banner ads to increase click-through rates and hence perceived effectiveness. Such efforts have included improved visuals or wording of ads, the addition of motion or audio, and the use of demographic targeting. However, such efforts fail to address some of the most basic failures of banner ads as a gateway to additional information.

An important shortcoming of a traditional banner ad is that a user who clicks on a banner ad is redirected to another website and thus taken away from the original Web site and distracted from whatever the user was originally doing. For example, a user reading a news site may be interested in a banner ad for auto insurance but, by clicking the insurance banner ad, is taken away from the news of the day to another Web page for exploring insurance options. Additionally, in many instances, the user who clicks on a banner ad is frequently taken to a new Web page which requires the user to provide information deemed necessary for the advertiser to supply the information that the user requested. In many instances, the user is required to provide information that identifies the user, can be used to identify the user, and/or can be used to provide additional communications to the user beyond the initial reply that the user is seeking. For instance, the web-site may require the user's email address so that an email can be sent to the user's computer with the requested information. Many web-sites indicate that such information can be provided to affiliates. These affiliates commonly send more emails to the user's computer, which in many cases are unwanted and/or relate to products/services that are of little or no interest to the user. While such additional email communications commonly offer the user the option of “opting-out” of future communications, the user is put to the trouble of having to opt-out. Even when a web-site indicates that the user related information will not be provided to other entities, the entity associated with the web-site that did receive the request frequently sends follow-up emails or other communications that are unwanted and/or do not relate to the information that the user was originally seeking. Again, the user is typically provided with the ability to opt-out of future email communications from the entity. However, as with the communications from affiliates, the user is still put to the trouble of opting-out. Further, when the additional communications are actual paper products received by regular post (i.e., snail mail), the user may not be provided with any readily discernable process for opting-out. In such situations, considerable time and effort may be required for the user to get off the mailing list that they never wanted to be on in the first place. Unwanted email and paper communications respectively are commonly referred to as “spam” and “junk mail.”

### SUMMARY OF THE INVENTION

The present invention is directed to a system and method that allow a user of a user computer system that is capable of Web communications to request information relating to an advertisement on a particular Web page that: (a) substantially avoids redirecting the user to a different Web page by causing the reply to the request to be provided to the user by a different communication channel, i.e., a channel other than the Web and (b) preserves the user's anonymity, thereby substantially reducing spam and/or junk mail. Examples of communication channels other than the Web include email, text messaging, facsimile, and regular mail. The information that is communicated over the different communication channel can take whatever form or forms are supported by the different communication channel. For example, the information can take the form of text, one or more still images, video, audio, combinations of these types of information, and links to these types of information to name a few.

One embodiment of the present invention is a system that is comprised of a user computer, an advertiser computer system, and an intermediary computer system, each of which is capable of transmitting and receiving communications over the Internet. The user computer allows a user to navigate to pages on the World Wide Web (hereinafter “the Web”) and, to the extent permitted by a particular page, interact with the page to navigate to other pages on the Web. The advertiser computer system can be comprised of a computer or a group of computers that cooperate with one another to cause an advertisement (e.g., a banner ad) to be conveyed over the Internet to the user computer and associated with a particular Web page requested by the user computer. Associated with the advertisement is a “button” or icon that allows the user of the user computer to request further information according to parameters specified by the user. The “button” or icon is not restricted to any particular type of Web page. For instance, the “button” or icon can be associated with a news, social media, or commercial Web page to name a few. The “button” or icon is a particular area associated with an advertisement that is displayed on an output peripheral of the user computer and that can be “actuated” using an input peripheral associated with the user computer, such as a mouse, touch screen, or other input peripheral. Actuation of the “button” or icon, in turn, causes the request to be issued. The intermediary computer system operates to: (a) receive the request for further information that occurs when a user causes (via the user computer) the “button” associated with the advertisement on the Web page to be “actuated” or clicked, (b) process the request to produce a revised request (i.e., a request that will result in a reply from the advertiser computer system being sent to the intermediary computer system instead of the user computer system) and a tag that allows the reply from the advertiser computer system to be associated with the user information that defines the address associated with the user and with the channel over which the user desires to receive the reply, (c) cause the revised request to be directed to the advertiser computer system, (d) receive the reply from the advertiser computer system, and (e) process the reply to produce a revised reply that can be conveyed to the user via the desired communication channel.

For example, if the user specifies that the reply is to be communicated to the user via email, the intermediary computer system processes the user's request for information to produce a revised request structured so that the reply is directed to the intermediary computer system. After the intermediary computer system receives the reply, the intermediary computer system uses the tag to associate the reply with the user's email address, processes the reply to produce a revised reply that is directed to the user's specified email address, and directs the revised reply to the user's email address. As such, the reply from the advertiser computer system is conveyed over the communication channel desired by the user and in a manner that preserves the user's anonymity by not revealing the user's email address to the advertiser computer system. In the example, it should be appreciated that at least the intermediary computer system has the ability to communicate via email. It should be further appreciated that the user may receive email using a computer that is different than the user computer that was employed to submit the request. Consequently, the user computer that was employed to submit the request may or may not have email capability. Further, while the advertiser computer system is likely to communicate with the intermediary computer system via the Web, it is also feasible that the reply from the advertiser computer system is conveyed to the intermediary computer system by email or some other communication channel.

The user can provide the information relating to the preferred communication channel for the reply before any requests are made or when the first request is made. In one embodiment, the user provides registration information prior to the intermediary computer system receiving a request from the user computer. This registration can be accomplished by any one or a combination of communication channels, including the Web, email, regular mail, and telephone (voice or texting). In most cases, it is expected that registration will be done over the Web. Further, when the registration is being done over the Web and before any requests are made, the registration process is not distracting a user from some other Web page. The registration can also be accomplished the first time that the user computer is used to actuate the “button” associated with an advertisement on a Web page being viewed on the output device of the user computer. In this case, actuating the “button” causes a new browser window to open on the user computer. The new browser window requests the needed registration information. To minimize the distraction that the new browser window may create with respect to the browser window that included the web page with the advertisement that included the “button”, the new browser window is preferably opened with a reduced or minimized “foot print.” As such, the user is typically still able to see the web page that included the advertisement with the “button”. It is also contemplated that such a registration could be accomplished by a drop down menu that appears when the “button” is actuated, thereby avoiding the need to open a new Web page. In any event, whatever distraction is associated with registration in this manner is a one-time distraction because any requests submitted subsequent to registration will not require the user to provide registration information. While it is also feasible that the user be required to provide the preferred communication channel and any other needed information each time a request is made, such an implementation is believed to be cumbersome. Regardless of when registration occurs, the registration process requires that the user provide profile information. Specifically, the user must identify the communication channel over which the user wants to receive a reply to a request and the user's address for the identified communication channel. Thereafter, any revised reply produced by the intermediary computer system is sent via the specified communication channel using the specified address information. For example, if the user indicates that the reply is to be sent by a text message and provides the telephone number to which the text message is to be directed, the intermediary computer system would produce a revised reply that is in the form of a text message directed to the noted telephone number. As should be appreciated with respect to this example, the intermediary computer system has the ability to generate and send text messages and the user, in addition to having access to a user computer system, has access to a telephone or telephone-like device that is capable of text messaging. While the advertiser computer system is likely to communicate a reply to the intermediary computer system using the Web, it is feasible that the reply from the advertiser computer system could be conveyed to the intermediary computer system by a text messaging channel or some other communication channel.

In another embodiment, the user can provide additional profile information when registering with the intermediary computer system. For instance, the user can specify the number of replies that the advertiser computer system can generate in reply to a request and that will be forwarded by the intermediary computer system to the user pursuant to the user specified channel and address. This allows the advertiser computer system to generate, for example, a limited number of follow-up communications but only up to the number of follow-up communications that the user considers acceptable. If the user does not provide additional profile information when registering, the intermediary computer system will use default values. For example, with respect to the number of replies to a request that the advertiser computer system can generate and that will be forwarded by the intermediary computer system to the user according to the user specified channel and address, the default value for the number of replies is one.

In another embodiment, once the user has provided the intermediate computer with the communication channel and address information, the intermediate computer provides the user with an account name and password that will allow the user to access their account information and, should the user want to do so, change values associated with one or more parameters. For instance, the user could change the email address to which any reply to a request is to be sent.

In yet another embodiment, when the user registers with the intermediary computer system, the user has at least a default profile and can be provided with at least one alternate profile. Further, the user can use their account name and password to access the default profile and any alternate profile and edit these profiles. While it is unlikely that the user would be restricted to the manner in which the default and any alternate profiles are used, it is expected that a user would use the default profile to specify the communication channel over which the user wants to receive replies when actuating a “button” associated with a Web advertisement in most instances and use any alternate profiles for situations involving a more focused search. For example, a user that is interested in purchasing a new car could set up an alternate profile indicating that the communication channel over which the replies are to be transmitted is regular mail and the address to which the regular mail is to be sent. In one embodiment, the user accesses their account at the intermediary computer system (typically, via a secure web-page) and activates the alternate profile prior to conducting their new car search on the web. After the user has employed the user computer to actuate the “buttons” associated with all the advertisements for the cars in which the user is interested, the user can return to the intermediary computer system to deactivate the alternate profile and reactivate the default profile. Alternatively, the alternative profile can be established so as to deactivate after the occurrence of an event (e.g., the elapse of specified amount time or the elapse of a certain amount of time without any new requests being received) and reactivate the default profile. In yet a further embodiment, the user can access their account on the intermediary computer system and set up an alternative profile such that the subsequent requests resulting from actuating a “button” associated with an advertisement are sent to the intermediary computer system but not forwarded to the relevant advertiser computer systems until the user accesses the intermediary website and indicates which requests are to be processed and forwarded. In one embodiment, the user can review the requests before they are processed and forwarded to the advertiser computer system, delete any redundant requests, and move requests that are to unrelated subject matter to the default profile or to a different alternate profile, specify the time at which a request is to be processed, specify a “subject line” that the replies associated with the processed requests should bear, and identify specific information that the user is interested in receiving in any reply to the request from the advertiser computer system.

In yet another embodiment, the user can utilize a profile to specify certain information that the advertiser computer system can request from the intermediary computer system relative to a request for additional information from a user. For instance, when the user establishes an alternate profile relating to a search for information on cars that the user might be interested in purchasing, the user can authorize the intermediary computer system to respond to a query from the advertiser computer system as to the number of requests made to competitors and the timing of such requests. This information may allow the manufacturer or dealer to identify a pattern associated with a user who is likely to make a purchase within a specified time and, in the reply, provide incentives that the user might find desirable.

### BRIEF DESCRIPTION OF THE DRAWINGS

FIG. 1 illustrates an embodiment of the system that includes a user computer, an intermediary computer system, an advertiser computer system, and a network (e.g., the Internet) for facilitating communications between the computers;

FIG. 2 is an example of a banner ad with a “button” or icon that, if actuated using an input device associated with the user computer, will cause a request for additional information related to the ad to be sent to the intermediary computer system;

FIG. 3 illustrates an embodiment of a user profile stored on the intermediary computer system and that allows a user to define the communication channel and address over which the user wants to receive a reply to a request for additional information relating to a Web advertisement;

FIG. 4 illustrates the sequence of communications between the user computer, intermediary computer system, and advertiser computer system that allow a user to receive additional information relating to a Web advertisement over a desired communication in a manner that preserves the user's anonymity; and

FIG. 5 illustrates a default user profile and an alternate user profile for a user that that facilitates more advanced communication protocols than the user profile illustrated in FIG. 2.

### DETAILED DESCRIPTION

FIG. 1 illustrates an embodiment of a system that allows a user to actuate a “button” associated with a Web advertisement to obtain additional information from the advertiser over a specified communication channel such that the anonymity of the user is preserved, hereinafter referred to as system 20. System 20 is comprised of: (a) a user computer 22 that allows a user to navigate the Web, receive Web pages, and interact with Web pages to navigate to other Web pages, (b) an advertiser computer system 24 that is capable of providing an advertisement that is at least a part of a Web page that is served to the user computer 22, (c) an intermediary computer system 26 that processes requests for additional information related to an advertisement on a Web page provided to the user computer that are initiated by the user computer 22 such that the reply from the advertisement computer system is conveyed to the user via a desired communication channel and in a manner that allows the user to preserve their anonymity relative to the advertiser computer system 24, and (d) a computer communication network 28 capable of supporting at least a certain subset of the communication protocols supported by the Internet and for facilitating communications between certain combinations of the user computer 22, advertiser computer system 24, and intermediary computer system 26.

The user computer 22 includes a processor, a memory, a browser application that allows the user to navigate and interact with Web pages, an output device that allows the user to view a selected Web page (e.g., a monitor or video display), and input device that allows the user to interact with a Web page (e.g., a mouse, keyboard, joy stick, track ball, light pen, touch screen etc.), a network interface for connecting the computer to the network 28, which can be wired or wireless. The user computer system 22 can take a number of forms. For instance, the user computer can be implemented in the form of a desktop computer, laptop computer, tablet computer, table-top computer built into a piece of furniture, and Web-enabled cellular telephone to name a few.

The advertiser computer system 24 can be comprised of one computer or a group of computers. Regardless of whether the advertiser computer system 24 is implemented with one or multiple computers, the system is capable of providing an advertisement that is at least a part of a Web page that is served to the user computer 22, via the network 28, with a “button” that allows the user to request additional information relating to the subject matter of the advertisement on the Web page and to do so in a manner that preserves the anonymity of the user is relative to the advertiser computer system 24. The advertiser computer system 24 is also capable of providing the requested additional information to the intermediary computer system 26 for processing before being conveyed to the user computer system. The advertiser computer system 24 is comprised of a processor, a memory, a Web application that facilitates the providing of a Web page in response to a request from a browser running on a user computer, and a network interface for connecting the system 24 to the network 28. If high volumes of network traffic are anticipated, the system 24 will typically employ a high speed processor and/or multiple processors, memory that typically includes a combination of high-speed volatile memory and high-speed non-volatile memory, and multiple network interfaces. The system 24 may include a dedicated output peripheral (e.g., monitor) and a dedicated input peripheral (e.g., keyboard, mouse, track ball etc.). However, the system 24, in certain embodiments of the invention, may not have any such dedicated peripherals or only one such peripheral. With such systems, personnel associated with the advertiser computer system typically can interact with the system via a network connection or, if needed, connect input and/or output peripherals to ports associated with the system on an as needed basis.

The intermediary computer system 26 can be comprised of one computer or a group of computers. In either case, the intermediary computer system 26 is capable of receiving a request for additional information generated when a user of the user computer 22 clicks on a “button” or icon associated with a Web page advertisement to indicate that the user wants to receive the additional information via a different communication channel than the Web (e.g., email, text messaging, facsimile, and regular mail to name a few) and in a manner that preserves the user's anonymity relative to the advertiser computer system 24. Preserving the user's anonymity relative to the advertiser computer system 24 means that at least the address associated with the user and with the different channel over which the user wants to receive the additional information is not communicated to the advertiser computer system 24. The intermediary computer 26 is also capable of processing such a request to produce a revised request that: (a) that does not include the address associated with the user and with the different communication channel over which the user wants to receive the additional information and (b) requires the advertiser computer system 24 to send the reply to the intermediary computer system 26. The revised request can be either a revision to the original request or a new request that is revised relative to the original request.

The processing also involves establishing a tag that allows whatever reply to the revised request is subsequently received to be matched with a profile for the user that identifies the communication channel over which the user wants to receive the reply and the user's address for the identified communication channel. The tag can take any of a number of forms. For example, the tag can be a value that is embedded in a field associated with the revised request, echoed in a field that accompanies the reply, and used as an index to the user's profile. The tag can also be a pointer that is associated with a specific issuance of a revised request to the advertiser computer system 24 by a browser employed by the intermediary computer 26 and used to access or locate the address associated with the user and the different communication channel over which the user wants to receive the additional information. The intermediary computer 26 causes the revised request to be directed to the advertiser computer system 24.

The intermediary computer 26 is also capable of processing the reply from the advertiser computer system 24. In this regard, the intermediary computer 26 uses the tag to access or locate the profile for the user that identifies the communication channel over which the user wants to receive the reply and the user's address for the identified communication channel, place the reply in a form suitable for communicating to the user via the communication channel requested by the user, and address the communication in a manner appropriate for the selected communication channel. The requested communication channel and address for that particular channel are set forth in the user's profile stored in or otherwise accessible by the intermediary computer system 26. The processed reply is then forwarded to the user via the selected communication channel. The reply from the advertiser computer system 24 is likely to be accomplished by a Web communication, but other channels for communicating the reply can also be used if needed or desired. It should be appreciated that the communication channel that the user has selected for receiving the reply may be an electronically implemented channel (e.g., email or text messaging) that the intermediary computer system 26 is capable of accessing or a channel that requires, at some point, the movement of information fixed on a tangible medium, such as paper (e.g., regular mail).

The intermediary computer system 26 is comprised of a processor, a memory, a Web application that facilitates communications with other computers and computer systems over the Web, and a network interface for connecting the system 26 to the network 28. If high volumes of network traffic are anticipated, the system 26 will typically employ a high speed processor and/or multiple processors, memory that typically includes a combination of high-speed volatile memory and high-speed non-volatile memory, and multiple network interfaces. The system 26 may include a dedicated output peripheral (e.g., monitor) and a dedicated input peripheral (e.g., keyboard, mouse, track ball etc.). The system 26, in certain embodiments of the invention, may not have any such dedicated peripherals or only one such peripheral. With such systems, personnel associated with the intermediary computer system typically can interact with the system via a network connection or, if needed, connect input and/or output peripherals to ports associated with the system on an as needed basis.

The network 28 is anticipated to be the Internet in most of the applications of the invention. However, other local area networks (LANs) or wide area networks (WANs) can be employed in appropriate situations.

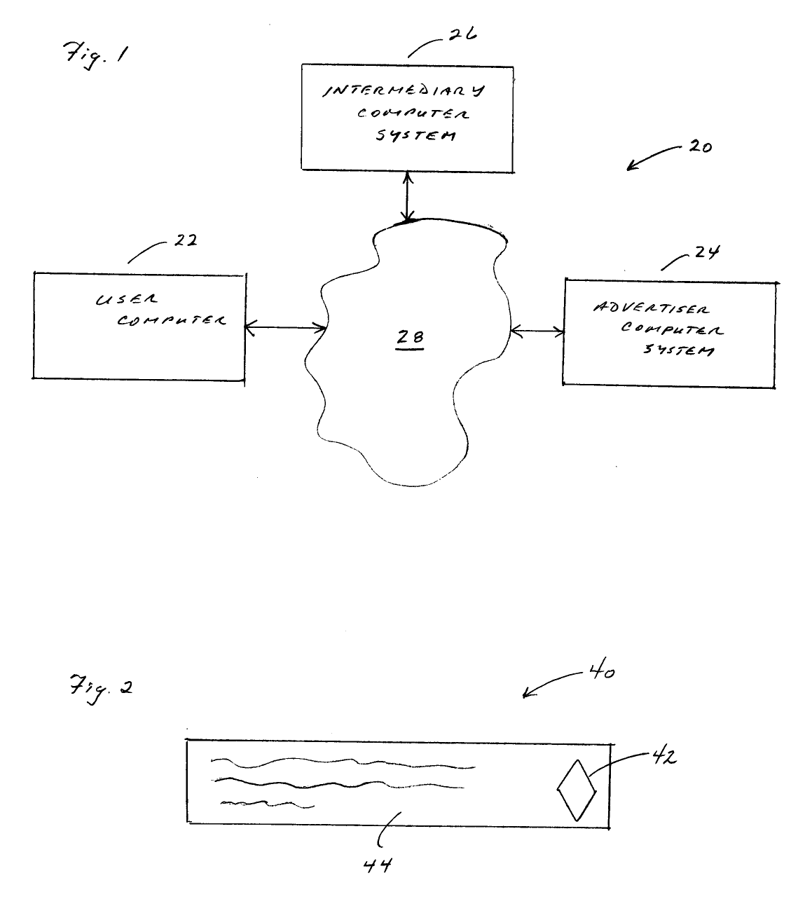

With reference to FIG. 2, an embodiment of a banner ad that is associated with a Web page and allows the user of the user computer 22 to request that further information relating the subject matter of the ad be delivered by a desired communication channel and in a manner that preserves the anonymity of the user, hereinafter ad 40, is described. The ad 40 includes a “button” or icon 42 that can be actuated by the user's manipulation of one of the input peripherals associated with the user computer 20. Typically, a mouse or track ball is the peripheral associated with the user computer 20 that is used to position a cursor over the button or icon 42 and to “actuate” the button 42. However, other peripherals can also used or adapted for this purpose. Associated with the button 42 is code that is executed in response to the actuation of the button and causes a request to be sent to the intermediary computer system 26 for additional information relating to the subject matter of the ad 40 that preserves the anonymity of the user. Typically, the portion of the ad 40 that does not constitute the button 42 can be actuated or clicked to cause a request for additional information to be sent to the advertiser computer system 24 without the request being processed by the intermediary computer system 26. Since clicking this portion of ad 40 results in the generation of a request that is sent to the advertiser computer system 24 without the request being processed by the intermediary computer system 26, just as most “clicks” on banner ads are currently processed, this portion of the ad is referred to as the standard click portion 44 of the ad 40. A banner ad without a standard click portion 44 and only a button 42 is feasible. It should be appreciated that the banner ad 40 is one type of ad that is used on the Web and that a button or icon like button or icon 42 can be associated or adapted to be associated with other types of advertisements used on the Web.

With reference to FIG. 3, an embodiment of a user profile 50 that is stored in or otherwise accessible to the intermediary computer system 26 and used by the system to provide a reply to the user pursuant to values specified by user and stored in the profile is described. The profile 50 includes a first field 52 that is used to designate the communication channel over which the user wants to receive any requested additional information. A second field 54 is used to provide the address information necessary to convey the requested information to the user over the designated communication channel. The profile 50 is associated with a user id and password that allows the user to access the intermediary computer system 26 to establish or alter the values in the first and second fields 52, 54 and, if desired, also change the user id and/or password. In the profile 50, the first field 52 has a drop down menu that allows the user to designate one of a email, text messaging, and regular mail as the communication channel over which a reply to a request for additional information is to be conveyed to the user or a communication device associated with the user. Depending on which channel is designated, the second field 54 is used to define the address that is to be associated with the communication over the selected channel. When email is selected as the channel for the reply, the user is required to provide an email address in the second field 54. Similarly, when text messaging is the selected channel for the reply, the user is required to provide a telephone number in the second field 54. When regular mail is the desired channel for the reply, the user must provide a postal address in the second field 54. The first field 52 can be adapted to accommodate more or fewer types of channels depending on the number of communication channels that the intermediary computer system 26 supports. For instance, a particular intermediary computer system may not support regular mail. Such as system, may only provide the user with the options of email and text messaging for receiving a reply email. On the other hand, if the intermediary computer system 26 supports facsimile communications in addition to email, text messaging and regular mail, then the profile 50 can be adapted to reflect that communications via a facsimile channel are an option. If a facsimile channel is supported by the intermediary computer system 26 and selected by a user, the user would be required to provide a telephone/facsimile number in the second field 54. In certain situations, it may only be necessary for the user to explicitly provide the address for the selected communication channel. For example, if the intermediary computer system 26 only supports one communication channel, then the user need only provide the address for that particular communication channel. The user may only need to explicitly provide the address for the selected communication channel if the selected communication channel can be inferred from the address. For example, if an email address can be distinguished from the addresses associated with the other types of communication channels supported by the intermediary computer system, then the user, in explicitly providing the email address, has also identified the desired communication channel as email.

Before describing the operation of the system 20, the establishment of a user account with the intermediary computer system 26 is described. Initially, the user establishes an account and profile with the intermediary computer system 26. The account and profile can be established using any of a number of communication channels or combinations of channels. Even though the establishment of an account can be accomplished using any of a number of communication channels or combinations thereof, it is anticipated that in most instances at least the account and profile will be established by the user employing their user computer to access a Web page or drop-down menu provided by the intermediary computer system 26 for the purpose of creating an account and establishing a profile. In most instances, it is anticipated that the account and related items will be established when a user employs a user computer to actuate the button 42 associated with a Web ad for the first time. Also feasible is the creation of the account and related items before the user actuates a button for the first time. It should be appreciated that the account associated with a particular user is likely to include other information that may be needed by the intermediary computer system 26 to communicate with the user computer 22 and that many users are unable to provide but that can be determined by the intermediary computer system 26 as part of the process of establishing an account, such as the IP address of the user computer 22. Further, the account is also likely to have certain default parameter values that may or may not be subsequently alterable by the user. For instance, the default value for the number of replies that can be generated by the advertiser computer system 24 and forwarded by the intermediary computer system 26 is typically set to one (1).

In one embodiment, the establishment of an account with the intermediary computer system 26 also causes an account id and password to be established for the account. The account id and password allow a user to access their account and change or modify the information in the account. For instance, subsequent to registration, the user may want or need to change the email address to which any replies are sent. The account id and password can be established in any number of ways. For instance, the user may be provided with the opportunity to specify an account id and password during the registration process. Alternatively, as part of or subsequent to registration, the intermediary computer system 26 may assign a user id and password and provide this information to the user pursuant to the communication channel and address information provided by the user. In any event, if the user accesses their account, the user is provided with an opportunity to change user id and/or password. The use of a user id and password facilitates changes to at least some of the information associated with the user's account subsequent to registration and/or access to more sophisticated profile features that the intermediary computer system 26 may want to provide. It should be appreciated, however, that the system could function without implementing a user id or password.

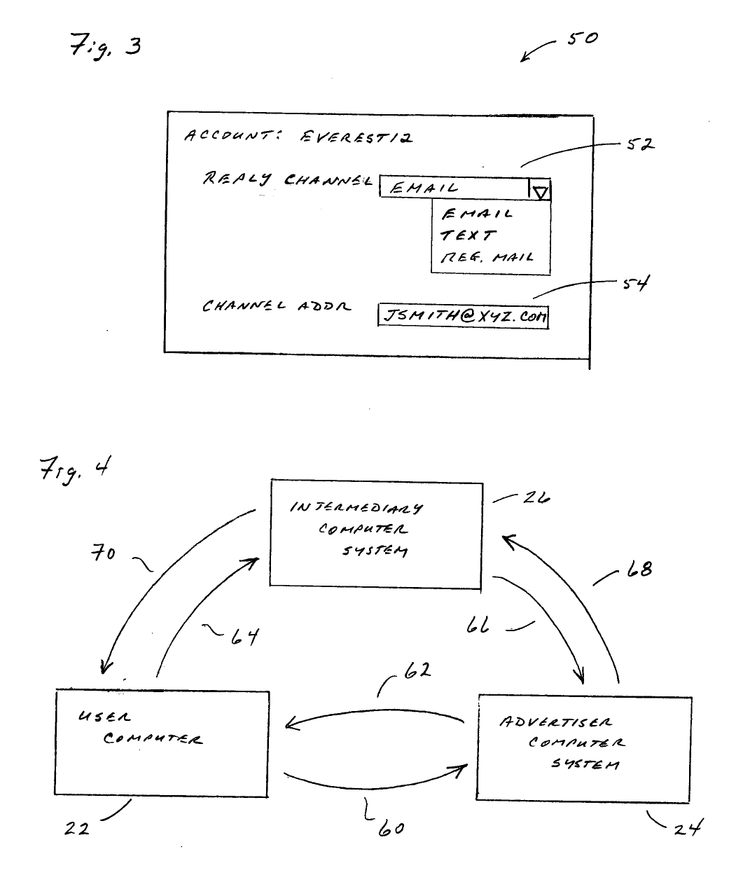

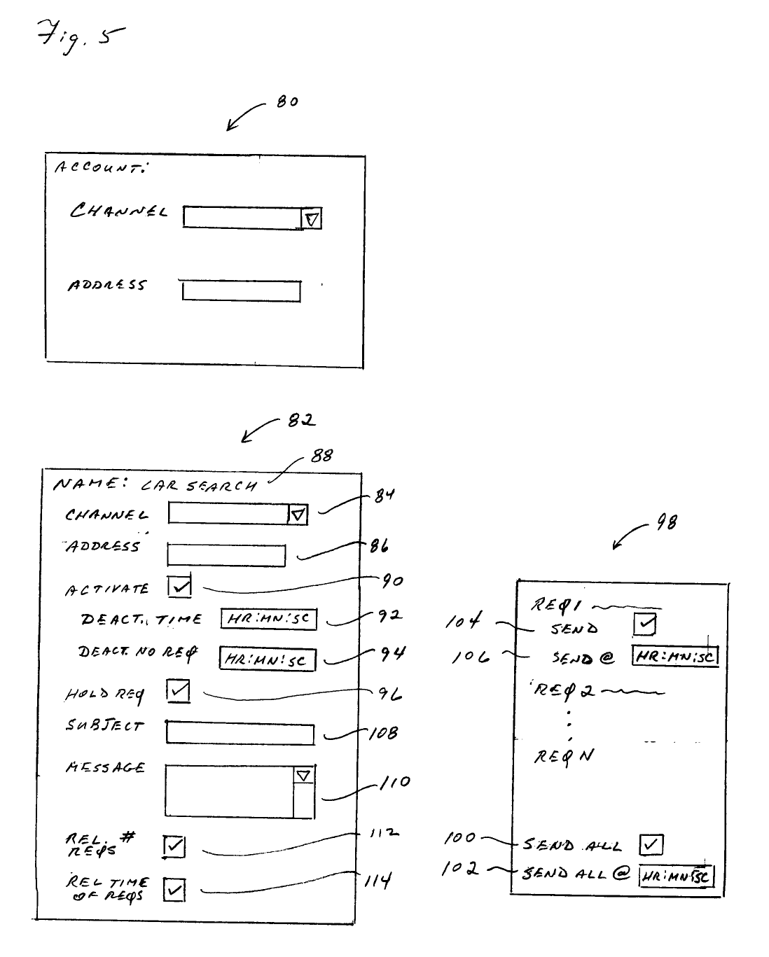

With reference to FIG. 4, the operation of the system 20 is described. The following description assumes the user has established an account with the intermediary computer system 26 and established a profile that identifies the communication channel over or through which the user wants to receive a reply to a request for further information relating to a Web advertisement and the address associated with the user for the selected communication channel. Initially, as identified by arrow 60, the user employs the user computer 22 and the browser application running on the computer to send a request as a Web communication via the network 28 for a particular Web page that will include an advertisement provided by the advertiser computer system 24, with the advertisement including the button 42. As shown in FIG. 4, the advertiser computer system 24 serves the entire Web page, including the advertisement, to the user computer 22. However, it should be appreciated that the request for the particular Web page may be directed to a computer system other than the advertiser computer system 24 and that this other computer system and the advertiser computer system 24 can cooperate to provide the requested Web page to the user computer 22. In such a situation, the advertiser computer system 24 provides the portion of the Web page that includes the advertisement with the button 42. In any case, the advertiser computer system 24 responds by at least providing the advertisement with the button 42 that is included in the requested Web page (arrow 62) provided to the user computer 22 as a Web communication via the network 28. The user is able to view the requested Web page on the output peripheral associated with the user computer 22. The Web ad includes the “button” 42 that allows the user to request additional information via a designated communication channel and in a manner that preserves the user's anonymity. The user utilizes an input peripheral associated with the user computer 22 and that cooperates with the browser application to actuate the “button”. This, in turn, causes a request for additional information relating to the advertised subject matter to be sent to the intermediary computer system 26 (arrow 64) as a Web communication via the network 28. Additionally, actuation of the “button” causes the “button” to change in some manner (e.g., shape or color) to indicate to the user that the request has been sent or is scheduled to be sent to the intermediary computer system 26.

The intermediary computer system 26 processes the request so as to produce a revised request for sending to the advertiser computer system 24 that will provoke a response from the advertiser computer system 24 being sent to the intermediary computer system 26 instead of to the user computer 24. In addition, the intermediary computer system 26 associates a tag with the request/revised request so that the reply subsequently received from the advertiser computer system 24 can be matched to the user profile that identifies the communication channel over which the user wants to receive the reply and the address associated with the communication channel. The intermediary computer system 26 sends the revised request to the advertiser computer system 24 (arrow 66). The revised request can be sent by any appropriate communication channel. However, it is anticipated that the revised request will be sent to the advertiser computer system 24 as a Web communication using the network 28.

The advertiser computer system 24 receives the revised request and, in response, produces a reply to the request that is sent to the intermediary computer system 26 (arrow 68). Again, the reply can be sent by any appropriate communication channel but it is anticipated that the reply will be sent as a Web communication using the network 28.

The intermediary computer system 26 receives the reply (arrow 68). The intermediary computer system 26 uses the tag to identify the profile that sets forth the communication channel over which the user wants to receive the reply and the address for the identified communication channel. The intermediary computer system 26 then processes the reply to produce a revised reply suitable for transmitting over or through the communication channel that the user has designated in their profile and to the address designated in the profile. The intermediary computer system 26 then sends the revised reply to the user (arrow 70). It should be appreciated that, while FIG. 4 shows the revised reply being sent to the user computer 22, the revised reply might not be sent to the user computer 22 depending on the selected communication channel. For instance, if the user selected text messaging and specified a telephone number that was not associated with the user computer 22, the revised reply would be sent elsewhere. Similarly, the reply would be sent to an actual physical address, and not the user computer 22, if the user selected regular mail.

With respect to the operation of the system 20, the revised request received by the advertiser computer system 24 and resulting from the actuation of the button 42 may be distinguishable from a conventional request received by the advertiser computer system 24 when a standard click portion associated with an advertisement is clicked or actuated. A standard click portion can be associated with an advertisement that does not include a button 42 or an advertisement that includes both a standard click portion and the button 42. If the revised request received by the advertiser computer system 24 is distinguishable from requests caused by actuating the standard click portion of an ad, the advertiser computer system 24 can provide a reply to a revised request that has different content from the reply provided in response to a conventional request. For example, when the request is seeking an insurance quote and the reply requests additional information needed from the user before a quote can be provided, the reply to the revised request may not request the user's name or address information and/or inform the user that to the extent the user does not want to provide one or more items of information, the subsequently provided quote will be in the form of a range to reflect the uncertainty associated with the missing item or items of information. However, in many instances, it is anticipated that the content of a reply to a revised request is expected to be substantially the same as the reply to a conventional request.

Further, if the revised request is distinguishable from the conventional request, the advertiser computer system 24 can use this information to cause the reply to be transmitted to the intermediary computer system 26 over a channel other than the Web channel over which the conventional reply is transmitted. However, in many instances, it is anticipated that the reply will be transmitted to intermediary computer system 26 over a Web channel, just as a reply to a conventional request would be transmitted. If the advertiser computer system 24 responds to a revised request over the same Web channel as the advertiser computer system 26 responds to a conventional request, the burden is on the intermediary computer system 26 to reformat or repackage the reply to the extent necessary to place the reply in a form that is suitable for communication over the user's desired communication channel. For example, if the reply from the advertiser computer system 24 is a Web page and the user has selected text messaging as the desired communication channel, the intermediary computer system 26 may create a text message with a hypertext link to the Web page. In addition, the intermediary computer system 26 causes the text message to be sent to the specified telephone number.

While the access of the intermediary computer system 26 to the user profile places the intermediary computer system 26 in an efficient position to reformat or repackage a reply to a revised request received from the intermediary computer system 26, it is also feasible for the advertiser computer system 24 to issue a reply to a revised request over a channel and/or in a format that reduces or eliminates any reformatting or repacking required of the intermediary computer system 26. However, the revised request that is sent by the intermediary computer system 26 to the advertiser computer system 24 needs to provide the necessary information for doing so. For example, if the reply of the advertiser computer system 24 is a Web page and the user's desired communication channel is text messaging, the revised request would indicate that the reply should be in the form of a text message to the intermediary computer system 24 and include tag information that allows the text message to be matched to the user's address for that desired communication channel. With the burden of reformatting the reply on the advertiser computer system 24 for the user's desired communication channel, the processing needed by the intermediary computer system 26 typically is reduced. More specifically, the operation of the intermediary computer system 26 in this instance involves matching the reply to the user's address for the desired communication channel, re-addressing the reply according to the address information in the user's profile, and forwarding the re-addressed reply to the user computer 22 or other device associated with the user.

In certain situations, the advertiser may want to off-load at least some of the burden of responding to requests resulting from the actuations of the button 42 to the intermediary computer system 26. In this situation, the advertiser provides the intermediary computer system 26 with the information necessary to respond to such requests. As such, there are no revised requests sent from the intermediary computer system 26 to the advertiser computer system 24 or any replies to such requests sent from the advertiser computer system 24 to the intermediary computer system 26.

Certain users may want or need greater control or options with respect to replies received in response to a request. To address this need, the intermediary computer system 26 can provide the user with additional profile options that can be established at the time of registration or established and/or altered subsequent to registration. Typically, access to these additional profile options is obtained by the user accessing their account with the user id and password for their. In this regard and with reference to FIG. 5, a default profile and an alternate profile for a user that provide the user with additional options with respect to requests for additional information transmitted to the intermediary computer system 26 are described. The intermediary computer system 26 provides the user with the ability to define a default profile 80 and at least one alternate profile 82. While the default profile 80 and alternate profile 82 can be set up as desired by the user, it is expected that the default profile 80 will be the profile that a user wants to use in most instances and the alternate profile 82 is a profile that the user wants to use for a specific or focused search on the Web. For purposes of illustration, default profile 80 is shown as being identical to the profile 50 shown in FIG. 3. It should, however, be appreciated that the default profile 80 can include additional fields such as those hereinafter described with respect to profile 82 if needed or desired. Profile 82 provides not only an alternative to profile 80 but also additional options with respect to any request for additional information that is forwarded to the intermediary computer system 26. Specifically, the alternate profile 82 includes a reply channel field 84 and a channel address field 86, just as in the default profile 80. In addition, the alternate profile 82 includes: (a) name field 88 that allows the user to specify a name for the profile (e.g., Car Search), (b) an activate profile button 90 that, if actuated, activates the alternate profile and deactivates the default profile or any other alternate profile that is currently active, (c) a terminate profile after a specified time field 92 that, should the user want to do so, allows the user to specify an amount of time that the alternate profile is to be used before being deactivated and the default profile reactivated, (d) a terminate profile after a specified time with no requests received field 98 that, should the user want to do so, allows the user to specify the amount of time without a request being received by the intermediary computer system 26 that the alternate profile will remain active before the alternate profile is deactivated and the default profile reactivated.

In addition, the alternate profile 82 includes a hold button 96 that, if actuated, causes the intermediary computer system 26 to hold each of the requests received from the user computer 22 until the user accesses the intermediary computer system 26 and, with respect to each such request, either authorizes the forwarding of the request to the relevant advertiser computer system 24 or otherwise dispose of the request. More specifically, if the hold button 96 is actuated, the user is provided with a log 98 that identifies the requests received from the user computer 22 that have not yet been processed and sent on to the relevant advertiser computer system 24. The user can edit the log 98 so as to delete requests or move requests to a different profile. Further, the user is provided with: (a) cause all of the requests to be processed and forwarded on to the relevant advertiser computer system or systems button 100, (b) cause all of the requests to be processed and forwarded on to the relevant advertiser computer system or systems after a specified time field 102, (c) cause an individual request to be processed and forwarded to the relevant advertiser computer system button 104, and (d) cause an individual request to be processed and forwarded to the relevant advertiser computer system after a specified time field 106.

The alternate profile 82 also includes a subject line field 108 that allows the user to specify a subject line that should be associated with the reply that is forwarded to the user via the communication channel designated by the user. For example, if the user designated email as the channel over which replies are to be transmitted and specified a subject line of “Car Research” in the profile 82, the intermediary computer system 26 would insert or assure that each email sent to the email address specified by the user included “Car Research” in the subject line. The user could, if desired, set up the email client so that emails with “Car Research” in the subject line are processed according to a filter established in the email. For instance, the email client could sort emails with “Car Research” in the subject line into a particular folder.

Also included in the alternate profile 82 is a message field 110 that allows a user to indicate specific information that the user is interested in receiving from the advertiser. For example, a user doing a new car search may be interested in particular engine specifications for the car that may not be included in the reply from the advertiser computer system. The user can draft a message requesting this information in the message field 110. The advertiser computer system 24 may or may not accept such inquiries.

The alternate profile 82 also includes: (a) an authorized to release number of requests processed under this profile to the advertiser computer system button 112 and (b) an authorization to release the timing of the requested processed under this profile to the advertiser computer system button 114. The release of the information to the advertiser computer system 24 is only done by the intermediary computer system 26 in response to a specific request or requests from the advertiser computer system 24. The number and/or timing of the requests under a profile may indicate a pattern that is indicative where the user is in the process of deciding to make a purchase. For example, if the number and/or timing of requests relating to cars indicate that the user is within a few days of making a decision as to which car to purchase, the advertiser may want to tailor the reply provided by the advertiser computer system 26 accordingly.

The foregoing description of the invention is intended to explain the best mode known of practicing the invention and to enable others skilled in the art to utilize the invention in various embodiments and with the various modifications required by their particular applications or uses of the invention.

What is claimed is:

1. A method comprising:
providing a user computer that is capable of receiving and transmitting Web communications;
receiving, using the user computer, a Web communication from an advertiser computer system, the Web communication including an advertisement with a button that, if actuated, represents a request for additional information relating to the advertisement and that a reply to the request be transmitted to an address associated with a user of the user computer system and with a communication channel other than the Web such that the address is not provided to the advertiser computer system; and
processing, using the user computer, an actuation of the button so as to transmit a request for additional information relating to the advertisement as a Web communication that is directed to an intermediary computer system.

2. A method, as claimed in claim 1, further comprising:
receiving, using the user computer, a Web communication with a request from the intermediary computer system to identify a communication channel other than the Web and over which a communication in reply to the request for additional information is to be conveyed.

3. A method, as claimed in claim 2, further comprising:
transmitting, using the user computer, Web communication with a reply to the request from the intermediary computer system that identifies the communication channel other than the Web and over which a communication in reply to the request for additional information is to be conveyed, the Web communication with the reply directed to the intermediary computer system.

4. A method, as claimed in claim 3, wherein:
the reply to the request from the intermediary computer system identifies one of: email, text messaging, facsimile, and regular mail as the communication channel other than the Web and over which a communication in reply to the request for additional information is to be conveyed.

5. A method, as claimed in claim 1, further comprising:
receiving, using the user computer, a Web communication with a request from the intermediary computer system to identify an address associated with a user of the user computer and with a communication channel other than the Web and over which a communication in reply to the request for addition information is to be conveyed.

6. A method, as claimed in claim 5, wherein the step of causing further comprises:
transmitting, using the user computer, a Web communication with a reply to the request from the intermediary computer system that identifies the address for the communication channel other than the Web and over which a communication in reply to the request for additional information is to be conveyed, the Web communication with the reply directed to the intermediary computer system.

7. A method, as claimed in claim 6, wherein:
the reply to the request from the intermediary computer system identifies one of: an email address, a text messaging telephone number, a facsimile number, and a regular mail address.

8. A method, as claimed in claim 1, further comprising:
receiving, in response to the request, at the address associated with the user of the user computer and with the communication channel other than the Web, the additional information.

9. A method, as claimed in claim 1, further comprising:
receiving, prior to the step of processing and using the user computer, a Web communication with a request from the intermediary computer system to identify a communication channel other than the Web and over which a communication in reply to a request for additional information is to be conveyed; and
transmitting, prior to the step of processing and using the user computer, a Web communication with a reply to the request from the intermediary computer system that identifies the communication channel other than the Web and over which a communication in reply to a request for additional information is to be conveyed, the Web communication with the reply directed to the intermediary computer system.

10. A method, as claimed in claim 1, further comprising:
receiving, prior to the step of processing and using the user computer, a Web communication with a request from the intermediary computer system to identify an address associated with a user of the user computer and with a communication channel other than the Web and over which a communication in reply to a request for addition information is to be conveyed; and
transmitting, prior to the step of processing and using the user computer, a Web communication with a reply to the request from the intermediary computer system that identifies the address for the communication channel other than the Web and over which a communication in reply to a request for additional information is to be conveyed, the Web communication with the reply directed to the intermediary computer system.

11. A method comprising:
providing an intermediary computer system that is capable of receiving Web communications;
receiving, using the intermediary computer system, a Web communication from a user computer, the Web communication from the user computer including a request for additional information relating to an advertisement associated with a Web communication provided to the user computer by an advertiser computer system, the request for additional information also being a request that a reply to the request be transmitted to an address associated with a user of the user computer system and with a communication channel other than the Web such that the address is not provided to the advertiser computer system
obtaining, using the intermediary computer system, a reply to the request without providing the address to the advertiser computer system; and
transmitting the reply to the request to the address associated with the user and with the communication channel other than the Web.

12. A method, as claimed in claim 11, wherein the step of obtaining comprises:
sending, using the intermediary computer system, a revised request directed to the advertiser computer system that requests a reply to the request but does not provide the address.

13. A method, as claimed in claim 12, wherein the step of obtaining comprises:
receiving, using the intermediary computer system, a reply to the revised request.

14. A method, as claimed in claim 13, wherein the step of transmitting comprises:
reformatting, using the intermediary computer system, the reply for the communication channel other than the Web.

15. A method, as claimed in claim 13, wherein the step of transmitting comprises:
addressing, using the intermediary computer system, the reply for the communication channel other than the Web.

16. A method, as claimed in claim 11, wherein the step of obtaining comprises:
obtaining, using the intermediary computer system, a reply to the request before receiving the request.

17. A method, as claimed in claim 11, further comprising:
transmitting, using the intermediary computer system, a Web communication directed to the user computer with a request to identify an address associated with the user of the user computer and with a communication channel other than the Web and over which a communication in reply to a request for additional information is to be conveyed; and
receiving, using the intermediary computer system, a Web communication from the user computer with a reply to the request that identifies the address and the communication channel other than the Web and over which a communication in reply to a request for additional information is to be conveyed.

18. A method comprising:
providing an advertiser computer system that is capable of receiving and transmitting Web communications;
receiving, using the advertiser computer system, a first Web communication from a user computer, the first Web communication from the user computer including a request that the advertiser computer system transmit a second Web communication to the user computer system that includes an advertisement, the advertisement including a button that, if actuated, represents a request for additional information relating to the advertisement and that a reply to the request be transmitted to an address associated with a user of the user computer system and with a communication channel other than the Web such that the address is not provided to the advertiser computer system;
causing, using the advertiser computer system, the second Web communication to be directed to the user computer;
providing, using the advertiser computer system, a reply to a request for additional information relating to the advertisement to an intermediary computer system.

19. A method, as claimed in claim 18, further comprising:
receiving, using the advertiser computer system and prior to the step of providing, a request from an intermediary computer system for additional information relating to the advertisement provided to the user computer.

20. A method comprising:
first conveying, using the Internet, a first Web communication from an advertiser computer system towards a user computer, the first Web communication including an advertisement with a button that, if actuated, represents a request for additional information relating to the advertisement and that a reply to the request be transmitted to an address associated with a user of the user computer system and with a communication channel other than the Web such that the address is not provided to the advertiser computer system; and
second conveying, using the Internet, a second Web communication towards an intermediary computer system, the second Web communication including a request for additional information relating to the advertisement associated with the first Web communication provided to the user computer by the advertiser computer system, the request for additional information also being a request that a reply to the request be transmitted to an address associated with a user of the user computer system and with a communication channel other than the Web such that the address is not provided to the advertiser computer system.

21. A method, as claimed in claim 20, further comprising:
third conveying, using the Internet, a third Web communication towards the user computer, the third Web communication system including a request for: (a) the identification of a channel other than the Web that a reply to a request for additional information is to be transmitted and (b) an address associated with the identified channel.

22. A method, as claimed in claim 21, wherein:
the step of third conveying occurs before the step of second conveying.

23. A method, as claimed in claim 21, wherein:
the step of third conveying occurs after the step of second conveying.
